(19) United States
(12) Patent Application Publication
(10) Pub. No.: US 2024/0042639 A1
(43) Pub. Date: Feb. 8, 2024

(54) SKIN TREATMENT SHEET AND SKIN TREATMENT DEVICE

(71) Applicants: The Gillette Company LLC, Boston, MA (US); Gesellschaft fur Diamantprodukte mbH, Neu-Ulm (DE)

(72) Inventors: Peter Bodo Gluche, Bellenberg (DE); Ralph Gretzschel, Neu-Ulm (DE); Michael Mertens, Vohringen/Illerberg (DE); Matthias Gester, Farnborough (GB); Robert Andrew Kearney, Reading (GB); Hannah Bryony Roberts, Ferndown (GB); Anthony William Shorey, Thatcham (GB)

(21) Appl. No.: 18/380,730

(22) Filed: Oct. 17, 2023

Related U.S. Application Data
(63) Continuation of application No. PCT/EP2022/060380, filed on Apr. 20, 2022.

(30) Foreign Application Priority Data
Apr. 20, 2021 (EP) 21169514.3

(51) Int. Cl. B26B 21/56

(52) U.S. Cl. CPC B26B 21/56

(57) ABSTRACT

The present invention relates to a skin treatment sheet comprising a substrate with a plurality of apertures wherein the sheet has a first surface and an opposing second surface. The apertures have a first and second inner perimeter and a cutting edge along at least a portion of the first inner perimeter. The skin treatment sheet has a stability ST which is the ratio of the average cross-sectional substrate area Ax and the total aperture area A1. Moreover, the present invention also relates to a skin treatment device comprising this skin treatment sheet.

### FIELD OF THE INVENTION

The present invention relates to a skin treatment sheet comprising a substrate with a plurality of apertures wherein the sheet has a first surface and an opposing second surface. The apertures have a first and second inner perimeter and a cutting edge along at least a portion of the first inner perimeter. The skin treatment sheet has a stability ST which is the ratio of the average cross-sectional substrate area Ax and the total aperture area A1. Moreover, the present invention also relates to a skin treatment device comprising this skin treatment sheet.

### BACKGROUND OF THE INVENTION

Traditional wet shave razors use linear steel blades to remove hair from the skin, for example known from DE 10 2004 052 068 A1. These wet shave razors produce a very close shave, where the hairs are cut either to skin level or below skin level, in the case of multi-blade razors. However, placing exposed blade edges onto the skin can result in damage to the skin and therefore irritation in particular if the skin bulges into the gaps between the blades.

In electric shaving devices, a foil acts as a barrier between the cutting element and the skin. These devices are often safer on the skin but produce a less close shave.

Skin treatment sheets aim to deliver both a close shave and an irritation free shave by placing a blade edge parallel to the skin and reducing the skin bulge by forming the cutting edges along the internal perimeter of a plurality of apertures, which are surrounded by a skin supporting substrate.

For the purposes of providing a robust and safe product, which can withstand the forces involved in shaving and the forces involved in manufacturing or dropping, it is important to consider the stability of the skin treatment sheet. The stability is determined by the ratio of the dimensions of the weakest points on the skin treatment sheet, which are defined by the smallest solid regions which separate and support each pair of adjacent cutting apertures, and the total open aperture area.

For the purposes of providing a structurally robust skin treatment sheet it is necessary to have a high stability and therefore it is desirable to have large solid supporting regions in between the cutting apertures, however this is not conducive to providing an efficient shave. For the purposes of providing an efficient shave it is preferential to have apertures which are large enough to facilitate effective hair feeding and to have a large number of apertures, in order to maximise the total amount of cutting edge on the skin treatment sheet. Therefore, a skin treatment sheet which is both structurally robust and which efficiently removes hair from a user's skin needs to effectively balance these two aspects of the product design.

Hair removal devices comprising a plurality of enclosed cutting edges have been disclosed in the art. In the majority of the art, the balance between the hair removal efficiency and the stability of the shaving surface has not been considered. In GB 2580088 A, the shaving surface has a high stability which is provided by a thick metal sheet, however the size of the apertures is insufficient to allow hairs to be fed into the apertures effectively. In other pieces of art, for example U.S. Pat. No. 7,124,511 B2 and DE 20 2019 100 514 U1, the structural rigidity and the ability to closely pack the cutting apertures is limited by processes used to create the blade edges. In the case of U.S. Pat. No. 7,124,511 B2 and DE 20 2019 100 514 U1, where etching processes are used to create the blade edge and to increase the structural rigidity, it is necessary to either increase the thickness of the substrate material or increase the spacing between the apertures. However, increasing the thickness of the material has an unintended consequence of increasing the distance between the apertures due to the etching process and the need to create an appropriate blade wedge angle to achieve a comfortable and efficient shave. In this case, the number of apertures which can be created within a given treatment sheet area is reduced resulting in a reduction in the total cutting length and a reduction in the hair removal efficiency.

The skin safety and hair removal efficiency resulting from the use of a skin treatment sheet containing a plurality of enclosed cutting edges is determined by the dimensions of the enclosed cutting edges, referred to herein as the apertures, the amount of skin support provided by the substrate material and the overall size of the treatment sheet.

The hair removal efficiency is determined by the total cutting length of the skin treatment sheet, which can be determined by summing the cutting lengths of all the apertures on the treatment sheet. This total cutting length should be maximized to increase the cutting efficiency.

The safety of the shave is determined by the area of contact between the skin and the substrate of the skin treatment sheet. For a safe shave, the area of contact between the skin and the substrate of the skin treatment sheet should be maximized.

However, the maximization of the total cutting length and the maximization of the substrate are counteracting features for which a satisfactory compromise between these features has not been found up to now. In the prior art, the dimensions of cutting apertures in skin treatment sheets with a plurality of enclosed cutting edges are disclosed, however the prior art does not disclose how to adequately balance the need for safety and hair removal efficiency. In the case of GB 2580088 A and DE 20 2019 100 514 U1 the size of the enclosed cutting edges are disclosed but whilst the open area formed within the perimeter of the enclosed cutting edge will provide a safe shave, the open area is too small to allow effective feeding of the hair into the aperture therefore resulting in poor cutting efficiency.

Moreover, to ensure a safe shave, the blade edges must not exert high pressure on the skin.

This is often achieved in shaving devices that use linear steel blades by mounting the blades onto springs so that the blades deflect away from the user's skin when the pressure on the blade increases. However, this has the disadvantage that the geometrical arrangement of the cutting edges relative to the skin, e.g., the angle of the blade bevel relative to the skin contacting surface, moves away from the optimum geometry during the deflection thus resulting in less efficient cutting of hairs.

When using skin treatment sheets with apertures formed from thin metal, a reduction of pressure on the skin can be achieved by embedding the treatment sheet into a deformable substrate as disclosed in EP 0 276 066 A1 or skin treatment sheets as disclosed in U.S. Pat. No. 4,984,365 and WO1992/002342 are able to deform across the entire surface when the user presses the shaving device against the skin. However, the flexibility of flexible metallic treatment sheet alters the geometrical arrangement of the cutting edges relative to the skin thus resulting in less efficient cutting of hairs and hence no flexible treatment sheets are available for hair removal to date.

When using flexible treatment sheets, additional rigidity needs to be provided to avoid deformation during shaving. As disclosed in U.S. Pat. No. 4,984,365, this can be achieved by integrating supportive structures around the skin treatment sheet in the device assembly to prevent undesirable bending of the treatment sheet when the user presses the shaving device against the skin. However, these additional supportive components add complexity to the shaving device and provide additional areas onto which debris can collect and result in the device being more difficult to clean.

It was therefore the object of the present invention to provide a skin treatment sheet with a good balance between high hair removal efficiency and good mechanical stability, i.e. rigidity, which allows a long durability of the device. Moreover, it was an object to provide a treatment sheet which is rigid and does not deform in use to provide consistent blade geometry throughout the shave and to ensure easy and effective cleaning of the device to remove shaving debris.

This object is solved by the skin treatment sheet with the features of claim 1 and the skin treatment device of claim 20. The further dependent claims refer to preferred embodiments of the invention.

The term “comprising” in the claims and in the description of this application has the meaning that further components are not excluded. Within the scope of the present invention, the term “consisting of” should be understood as preferred embodiment of the term “comprising”. If it is defined that a group “comprises” at least a specific number of components, this should also be understood such that a group is disclosed which “consists” preferably of these components.

### SUMMARY OF THE INVENTION

The following definitions are used for describing the present invention:

### Aperture Area a1

The area a1 of an aperture on the first surface of the skin treatment sheet is defined as the open area enclosed by the aperture perimeter r1.

### Total Aperture Area A1

The treatment sheet comprises a number n of apertures, each with an aperture area a1ᵢ (i=1 to n) on the first surface. The summation of all the aperture areas a1ᵢ for all n apertures results in the total aperture area A1 which is calculated according to the formula:

A1=Σᵢ₋₁ⁿa1ᵢ,i=1 to n

Aperture Cutting Length l1 The apertures have a cutting edge along at least a portion of the first inner perimeter. The cutting length l1ᵢ (i=1 to n) of an aperture on the first surface of the skin treatment sheet is defined as the length of the portion along the inner perimeter r1 where a cutting edge is provided within the aperture.

### Total Cutting Length L1

The skin treatment sheet comprises a number n of apertures, each with an aperture cutting length l₁. The summation of all the cutting length l₁ for all n apertures results in the total cutting length L1 which is calculated according to the formula:

L1=Σᵢ₌₁ⁿl1ᵢ,i=1 to n

### Total Sheet Area S

The skin treatment sheet has an outer treatment sheet perimeter R. The area enclosed by this outer perimeter is the total sheet area S.

### Closest Adjacent Aperture Dstance b1ᵢ

The skin treatment sheet comprises a number n of apertures. For each aperture i a closest adjacent aperture can be found. A straight line X′⁻″ starting on any point p′ located on the inner perimeter of a first aperture and ending on any point p″ located on the inner perimeter of a second aperture can be drawn. The shortest aperture separation b1ᵢ between aperture i and the closest adjacent aperture is defined as the length of the shortest line X′⁻″ that can be drawn in such a way between these two closest adjacent apertures.

### Cross Sectional Substrate Area axᵢ

A vertical cross section taken through the skin treatment sheet perpendicular to the first surface along a line of b1ᵢ determines an area axᵢ that is bounded by b1ᵢ a corresponding minimum aperture distance b2ᵢ on the second surface of the skin treatment sheet and two bevels that connect the inner perimeter on the first surface to the inner perimeter on the second surface. The average cross-sectional substrate area of the skin treatment sheet Ax is the average of all n individual cross sectional substrate areas axᵢ measured over the entire skin treatment sheet:

$$A x = \frac{{\sum }_{i = 1}^{n} a {x}_{i}}{n} , i = 1 to n$$

### Transparency T

The transparency T of a treatment sheet is defined as the ratio of the total aperture area A1 divided by the total treatment sheet area S.

### Rim Width W1

The treatment sheet comprises a number n of apertures. The rim width W1 is the shortest distance that can be measured from the outer perimeter R to the inner perimeter r1 of any of the apertures adjacent to the outer perimeter R.

### Stability ST

The stability ST of the treatment sheet is defined as the ratio of the average cross sectional substrate area Ax and the total aperture area A1.

According to the present invention a skin treatment sheet comprising a substrate with a plurality of n apertures is provided, wherein:
the sheet has a first surface and an opposing second surface,
the apertures have a first inner perimeter at the first surface and a second inner perimeter at the opposing second surface,
at least two apertures have a cutting edge along at least a portion of the first inner perimeter,
each aperture has a closest adjacent aperture which is connected by a shortest distance line bli on the first surface with a vertical cross-sectional substrate area axi along the distance line b1ᵢ,
the treatment sheet has an average cross-sectional substrate area Ax defined as the average of all cross-sectional substrate areas axᵢ
the skin treatment sheet has a stability ST, defined by the ratio of the average cross sectional substrate area Ax and the total aperture area A1,
the skin treatment sheet has a total cutting length L1,
wherein the product of stability and total cutting length ST×L1 ranges from 0.01 to 10 mm.

### Skin Contacting Surface

The skin contacting surface is the continuous surface defined by the first surface of the skin treatment sheet.

### Tip Radius TR

In FIG. 11, it is shown how the tip radius TR of a cutting edge can be determined. The tip radius TR is determined by first drawing a line 60 bisecting the cross-sectional image of the first bevel of the cutting edge 1 in half. Where line 60 bisects the first bevel point 65 is drawn. A second line 61 is drawn perpendicular to line 60 at a distance of 110 nm from point 65. Where line 61 bisects the first bevel two additional points 66 and 67 are drawn. A circle 62 is constructed from points 65, 66 and 67. The radius of circle 62 is the tip radius TR for the cutting edge. The definition of the tip radius is determined according to FIG. 11 It is preferred that at least half of the n apertures, more preferably 80% of then apertures and even more preferably all apertures have a cutting edge along at least a portion of the first inner perimeter.

It is preferred that the product of stability and total cutting length ST×L1 is from 0.05 to 5 mm, more preferably from 0.1 to 2 mm.

It has been surprisingly found that the chosen product of the stability ST and the total cutting length L1 allows a good balance between a close shave and a stable skin treatment sheet.

It is further preferred that the stability ST is in the range from 1×10⁻⁴ to 1×10⁻¹, preferably from 2×10⁻⁴ to 5×10⁻², and more preferably from 1×10⁻³ to 2×10⁻².

It is preferred that adjacent apertures are connected by a shortest distance line b2ᵢ on the second surface and the ratio b1ᵢ: b2ᵢ is in the range of 1.0 to 10.0, preferably from 1.3 to 5.0, more preferably from 1.4 to 4.0 and even more preferably from 1.5 to 3.2.

According to a preferred embodiment, the shortest distance b1ᵢ on the first surface is in the range of 0.1 to 3.5 mm, preferably 0.2 to 2.0 mm, more preferably 0.5 to 1.5 mm, and even more preferably from 0.7 to 1.2 mm. By ensuring b1ᵢ has a value within this range, the skin treatment sheet can deliver an efficient and safe shave.

The skin treatment sheet according to the present invention has preferably a cross-sectional substrate area axᵢ in the range from 0.01 to 1 mm², preferably from 0.03 to 0.55 mm², and more preferably from 0.1 to 0.3 mm².

It has been found that the overall size of the treatment sheet is critical to maintain a balance between shaving large areas such as the cheek or leg and shaving more precise areas such as the upper lip. The total skin treatment sheet area S is preferably in the range from 100 to 800 mm², more preferably from 200 to 600 mm², and even more preferably from 250 to 480 mm².

It is preferred that the total aperture area A1 is from 10 to 400 mm², more preferably from 20 to 200 mm², and even more preferably from 40 to 120 mm².

Furthermore, it has been found that the safety of the shave is affected by the transparency of the skin treatment sheet, which is defined as the total amount of open area of the skin treatment sheet relative to the amount of solid material. The solid substrate of the skin treatment sheet maintains contact with the skin during use and prevents excessive skin bulging into the apertures, which may result in skin damage and irritation. When the transparency of the skin treatment sheet is high the skin is not sufficiently supported and is able to bulge into the apertures resulting in skin damage and irritation. The transparency of the sheet is therefore preferably in the range from 5 to 60%, more preferably from 10 to 50%, and even more preferably from 15 to 30%.

According to a preferred embodiment the total cutting edge length L is in the range from 20 to 600 mm, more preferably from 30 to 400 mm, and even more preferably from 45 to 120 mm.

It is preferred that the skin treatment sheet has an outer perimeter R with a rim width W1, wherein the rim width W1 is preferably in a range from 0.1 to 5.0 mm, preferably from 0.5 to 3.0 mm, more preferably from 1.0 to 2.0 mm.

According to a preferred embodiment the first inner perimeter is smaller than the second inner perimeter. This allows for improved rinsing or clearing of debris, like hairs or dead skin. For a circular two-dimensional shape of the aperture this results in a conical thee-dimension aperture which is less susceptible to clogging of the aperture by hairs or dead skin.

The skin treatment sheet has preferably a thickness of 20 to 1000 μm, more preferably 30 to 500 μm, and even more preferably 50 to 300 μm.

The substrate has preferably from 5 to 200 apertures, more preferably from 10 to 120 apertures, and even more preferably from 15 to 80 apertures which corresponds to the number n, i.e. n ranges preferably from 5 to 200, more preferably from 10 to 120, and even more preferably from 15 to 80.

According to a preferred embodiment of the cutting element, the substrate comprises a first material, more preferably essentially consists of or consists of the first material.

According to another preferred embodiment the substrate comprises a first and a second material which is arranged adjacent to the first material. More preferably, the substrate essentially consists of or consists of the first and second material. The second material can be deposited as a coating at least in regions of the first material, i.e. the second material can be an enveloping coating of the first material, or a coating deposited on the first material on the first face.

For optimal shaving it is necessary to have blades which are rigid to withstand deformation during shaving and blade edges which are strong to withstand the forces involved in hair cutting.

Conventional steel blades are made from thin strip material to form a blade bevel with a small angle to minimize the force to cut the hair. However, such blades are very flexible, and rigidity has to be provided by adding a blade support as a rigid frame onto which the thin blade edge is mounted. Without this support conventional steel blades formed from a thin metal strip would not be sufficiently rigid. The same applies to treatment sheets made from thin metal sheet as disclosed in U.S. Pat. No. 4,984,365 and WO1992/002342.

However, using thin metal cutting edges has the disadvantage that it requires complex assembly to ensure rigidity of the blades.

Skin treatment sheets formed from a material such as silicon are sufficiently rigid and enable simpler assembly. However, silicon blade edges that have small bevel angles to cut hairs at low force are very brittle and the edges will break under the forces required to cut hair, hence no silicon razor blades, or treatment sheets made from silicon are available for hair removal to date.

It was surprisingly found that the combination of a first and second material allows to provide cutting blades and treatment sheets, respectively, which are rigid to withstand deformation during shaving without needing any supporting structures. Furthermore, the cutting blades and treatment sheets, respectively, have blade edges which are strong to withstand the forces involved in hair cutting.

It is preferred that the first material is different from the second material, more preferably the second material has a higher hardness and/or a higher modulus of elasticity and/or a higher rupture stress than the first material.

The material of the first material is in general not limited to any specific material as long it is possible to bevel this material.

However, according to an alternative embodiment the blade body comprises or consists only of the first material, i.e. an uncoated first material. In this case, the first material is preferably a material with an isotropic structure, i.e. having identical values of a property in all directions. Such isotropic materials are often better suited for shaping, independent from the shaping technology.

The first material preferably comprises or consists of a material selected from the group consisting of:
metals, preferably titanium, nickel, chromium, niobium, tungsten, tantalum, molybdenum, vanadium, platinum, germanium, iron, and alloys thereof, in particular steel,
ceramics comprising at least one element selected from the group consisting of carbon, nitrogen, boron, oxygen or combinations thereof, preferably silicon carbide, zirconium oxide, aluminum oxide, silicon nitride, boron nitride, tantalum nitride, AlTiN, TiCN, TiAlSiN, TiN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face, wafer orientation <100>, <110>, <111>or <211>,
single crystalline materials,
glass or sapphire,
polycrystalline or amorphous silicon or germanium,
mono- or polycrystalline diamond, micro-crystalline, nano-crystalline and/or ultranano-cystalline diamond, diamond like carbon (DLC), adamantine carbon and
combinations thereof.

The steels used for the first material are preferably selected from the group consisting of 1095, 12C27, 14C28N, 154CM, 3Cr13MoV, 4034, 40X10C2M, 4116, 420, 440A, 440B, 440C, 5160, 5Cr15MoV, 8Cr13MoV, 95X18, 9Cr18MoV, Acuto+, ATS-34, AUS-4, AUS-6 (=6A), AUS-8 (=8A), C75, CPM-10V, CPM-3V, CPM-D2, CPM-M4, CPM-S-30V, CPM-S-35VN, CPM-S-60V, CPM-154, Cronidur-30, CTS 204P, CTS 20CP, CTS 40CP, CTS B52, CTS B75P, CTS BD-1, CTS BD-30P, CTS XHP, D2, Elmax, GIN-1, H1, N690, N695, Niolox (1.4153), Nitro-B, S70, SGPS, SK-5, Sleipner, T6MoV, VG-10, VG-2, X-15T.N., X50CrMoV15, ZDP-189.

It is preferred that the second material comprises or consists of a material selected from the group consisting of:
oxides, nitrides, carbides, borides, preferably aluminum nitride, chromium nitride, titanium nitride, titanium carbon nitride, titanium aluminum nitride, cubic boron nitride,
boron aluminum magnesium,
carbon, preferably diamond, poly-crystalline diamond, nano-crystalline diamond, diamond like carbon (DLC), and
combinations thereof.

Moreover, all materials cited in the VDI guideline 2840 can be chosen for the second material.

The second material is preferably selected from the group consisting of TiB₂, AlTiN, TiAlN, TiAlSiN, TiSiN, CrAl, CrAlN, AlCrN, CrN, TiN,TiCN and combinations thereof

It is particularly preferred to use a second material of nano-crystalline diamond and/or multilayers of nano-crystalline and microcrystalline diamond as second material. Relative to monocrystalline diamond, it has been shown that the production of nano-crystalline diamond, compared to the production of monocrystalline diamond, can be accomplished substantially more easily and economically. Moreover, with respect to their grain size distribution nano-crystalline diamond layers are more homogeneous than polycrystalline diamond layers, the material also shows less inherent stress. Consequently, macroscopic distortion of the cutting edge is less probable.

It is preferred that the second material has a thickness of 0.15 to 20 μm, preferably 2 to 15 μm and more preferably 3 to 12 μm.

It is preferred that the second material has a modulus of elasticity (Young's modulus) of less than 1200 GPa, preferably less than 900 GPa, more preferably less than 750 GPa and even more preferably less than 500 GPa. Due to the low modulus of elasticity the hard coating becomes more flexible and more elastic. The Young's modulus is determined according to the method as disclosed in Markus Mohr et al., “Youngs modulus, fracture strength, and Poisson's ratio of nanocrystalline diamond films”, J. Appl. Phys. 116, 124308 (2014), in particular under paragraph III. B. Static measurement of Young's modulus.

The second material has preferably a transverse rupture stress σ₀ of at least 1 GPa, more preferably of at least 2.5 GPa, and even more preferably at least 5 GPa.

With respect to the definition of transverse rupture stress σ₀, reference is made to the following literature references:
R.Morrell et al., Int. Journal of Refractory Metals & Hard Materials, 28 (2010), p. 508-515;
R. Danzer et al. in “Technische keramische Werkstoffe”, published by J. Kriegesmann, HvB Press, Ellerau, ISBN 978-3-938595-00-8, chapter 6.2.3.1 “Der 4-Kugelversuch zur Ermittlung der biaxialen Biegefestigkeit sproder Werkstoffe.”

The transverse rupture stress σ₀ is thereby determined by statistical evaluation of breakage tests, e.g. in the B3B load test according to the above literature details. It is thereby defined as the breaking stress at which there is a probability of breakage of 63%.

Due to the extremely high transverse rupture stress of the second material the detachment of individual crystallites from the hard coating, in particular from the cutting edge, is almost completely suppressed. Even with long-term use, the cutting blade therefore retains its original sharpness.

The second material has preferably a hardness of at least 20 GPa. The hardness is determined by nanoindentation (Yeon-Gil Jung et. al., J. Mater. Res., Vol. 19, No. 10, p. 3076).

The second material has preferably a surface roughness R_{RMS} of less than 100 nm, more preferably less than 50 nm, and even more preferably less than 20 nm, which is calculated according to:

$${R}_{R M S} = ( \frac{1}{A} ) \int \int {Z ( x , y )}^{2} dxdy$$

A=evaluation area
Z(x,y)=the local roughness distribution

The surface roughness Riuvis is determined according to DIN EN ISO 25178. The mentioned surface roughness makes additional mechanical polishing of the grown second material superfluous.

In a preferred embodiment, the second material has an average grain size d₅₀ of the nano-crystalline diamond of 1 to 100 nm, preferably 5 to 90 nm, more preferably from 7 to 30 nm, and even more preferably 10 to 20 nm. The average grain size d₅₀ is the diameter at which 50% of the second material is comprised of smaller particles. The average grain size d₅₀ may be determined using X-ray diffraction or transmission electron microscopy and counting of the grains.

According to a preferred embodiment, the first material and/or the second material are coated at least in regions with a low-friction material, preferably selected from the group consisting of fluoropolymer materials like PTFE, parylene, polyvinylpyrrolidone, polyethylene, polypropylene, polymethyl methacrylate, graphite, diamond-like carbon (DLC) and combinations thereof.

Moreover, the apertures have a shape which is selected from the group consisting of circular, ellipsoidal, square, triangular, rectangular, trapezoidal, hexagonal, octagonal or combinations thereof.

The aperture area a1ᵢ on the first surface of the skin treatment sheet is defined as the open area enclosed by the perimeter. The aperture area a1ᵢ ranges preferably from 0.2 mm² to 25 mm², more preferably from 1 mm² to 15 mm², and even more preferably from 2 mm 2 to 12 mm².

The cutting edge ideally has a round configuration which improves the stability of the cutting element. The cutting edge has preferably a tip radius TR of less than 200 nm, more preferably 1 to 200 nm, more preferably 10 to 100 nm and even more preferably 20 to 50 nm.

To cut hair efficiently, the tip of the cutting edge has to exert high pressure on the hair.

This is achieved in shaving devices that use linear steel blades by orienting the blade bevel at an angle relative to the skin contacting surface of the product resulting in cutting edges that protrude beyond the skin contacting surface and are exposed above the skin contacting surface towards the skin of the user. The same applies to treatment sheets formed out of thin metal as disclosed in WO1992/002342 where the blade edges are angled relative to the skin contacting surface and protrude beyond the skin contacting surface and are exposed above the skin contacting surface towards the skin of the user. However, this arrangement can also cut the skin and lead to skin irritation and discomfort, it is therefore not a safe shaving device and hence no treatment sheets with these blade arrangements are available for hair removal to date.

To be safe on skin, the skin facing side of the blade bevel must be coplanar with the skin contacting surface of the device, i.e., the edge must not be exposed above the skin contacting plane. Also, the tip of the cutting edge must be as close as possible to the skin, i.e., it should lie within the skin contacting surface, i.e., it should be coincident with the skin contacting surface. However, this reduces the tip pressure onto the hair and thus the cutting efficiency and therefore no treatment sheets with non-protruding blade edges made from a metallic material (Leonard) are available to date.

The tip pressure can be increased by making the blades “sharper” i.e., by reducing the tip radius. Such treatments sheets could be formed e.g. with silicon, however silicon is very brittle and sharp edges will break under the forces required to cut hair and hence no silicon treatment sheets are available for use to date.

It was surprisingly found that durable cutting edges are provided according to the present invention which are coplanar to the skin contacting surface and have a small tip radius of less than 200 nm.

It is preferred that the tip radius TR is coordinated to the average grain size d₅₀ of the hard coating. It is hereby advantageous in particular if the ratio between the tip radius TR of the second material at the cutting edge and the average grain size d₅₀ of the nanocrystalline diamond hard coating TR/d₅₀ is from 0.03 to 20, preferably from 0.05 to 15, and particularly preferred from 0.5 to 10.

The skin treatment sheet according to the present invention may be used in the field of hair or skin removal, e.g. shaving, dermaplaning, callus skin removal.

Moreover, according to the present invention a skin treatment device is provided comprising the skin treatment sheet as defined above.

### BRIEF DESCRIPTION OF THE DRAWINGS

The present invention is further illustrated by the following figures which show specific embodiments according to the present invention. However, these specific embodiments shall not be interpreted in any limiting way with respect to the present invention as described in the claims and in the general part of the specification.

FIG. 1a is a first perspective view of skin treatment sheets in accordance with the present invention,

FIG. 1b is a second perspective view of skin treatment sheets in accordance with the present invention,

FIG. 2a is a first top view of the first surface of a skin treatment sheet in accordance with the present invention,

FIG. 2b is a second top view of the first surface of a skin treatment sheet in accordance with the present invention,

FIG. 2c is a third top view of the first surface of a skin treatment sheet in accordance with the present invention,

FIG. 3 is a top view onto the second surface of a cutting element in accordance with the present invention,

FIG. 4a is a top view of the first surface of an alternative skin treatment sheet in accordance with the present invention,

FIG. 4b is a top view of the first surface of a further skin treatment sheet in accordance with the present invention,

FIG. 5 is a cross-sectional view of two cutting apertures with straight bevels in accordance with the present invention,

FIG. 6 is a cross-sectional view of two cutting apertures with a first and a second material in accordance with the present invention,

FIG. 7a shows a top view onto the second surface of a first alternative for a cutting aperture in accordance with the present invention,

FIG. 7b shows a top view onto the second surface of a second alternative for a cutting aperture in accordance with the present invention,

FIG. 7c shows a top view onto the second surface of a third alternative for a cutting aperture in accordance with the present invention,

FIG. 7d shows a top view onto the second surface of a fourth alternative for a cutting aperture in accordance with the present invention,

FIG. 8a shows a top view onto the second surface of a first alternative of a treatment sheet in accordance with the present invention,

FIG. 8b shows a top view onto the second surface of a second alternative of a treatment sheet in accordance with the present invention,

FIG. 8c shows a top view onto the second surface of a third alternative of a treatment sheet in accordance with the present invention,

FIG. 8d shows a top view onto the second surface of a fourth alternative of a treatment sheet in accordance with the present invention,

FIG. 8e shows a top view onto the second surface of a fifth alternative of a treatment sheet in accordance with the present invention,

FIG. 9a shows a top view of a sixth alternative of a treatment sheet in accordance with the present invention,

FIG. 9b shows a top view of a seventh alternative of a treatment sheet in accordance with the present invention,

FIG. 9c shows a top view of a eighth alternative of a treatment sheet in accordance with the present invention,

FIG. 9d shows a top view of a ninth alternative of a treatment sheet in accordance with the present invention,

FIG. 10 is a flow chart of the process for manufacturing the skin treatment sheets,

FIG. 11 is a cross sectional view of a cutting edge showing the determination of the tip radius,

### REFERENCE SIGN LIST

4, 4′,4″, 4′″ cutting edges

18 first material

19 second material

22 substrate

40 skin treatment sheet

41 first surface

42 second surface

60 bisecting line

61 perpendicular line

62 circle

65 construction point

66 construction point

67 construction point

101 silicon wafer

102 silicon nitride layer

103 photoresist layer

104 diamond layer

430,430′,430″,430′″ apertures

431,431′,431″, 431′− inner aperture perimeters at first surface

432,432′ inner perimeter at second surface

R outer perimeter of skin treatment sheet

S sheet area

a1ᵢ, a1, aperture areas

r1ᵢ, r1, inner aperture perimeters

X′⁻″ straight line between adjacent apertures

p′ starting point of straight line at the first aperture

p″ starting point of straight line at the second aperture adjacent to first aperture

W1 rim width

I1ᵢ cutting length of aperture

L1 total cutting length

b1ᵢ shortest aperture separations on first surface

b2ᵢ shortest aperture separations on second surface

### DETAILED DESCRIPTION OF THE INVENTION

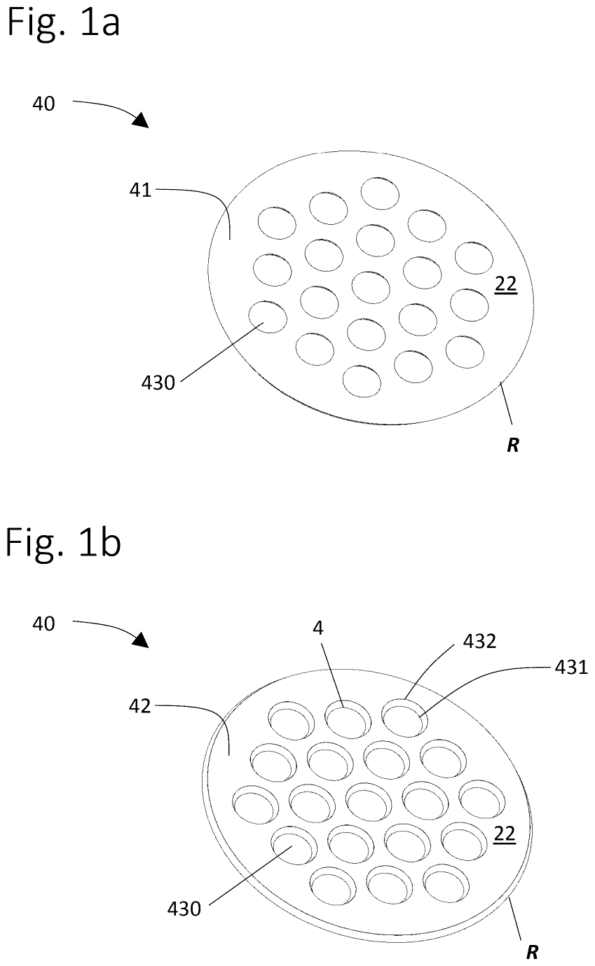

FIG. 1a shows a treatment sheet 40 of the present invention in a perspective view looking onto the first surface 41. The treatment sheet 40 comprises a substrate 22 with apertures 430 having an outer perimeter R.

FIG. 1b shows a treatment sheet 40 of the present invention in a perspective view looking onto the second surface 42 which is opposite to the first surface 41. The treatment sheet 40 comprises the substrate 22 with the apertures 430 having an outer perimeter R. It can be seen that the cutting edges are shaped along the inner perimeter 431 located at the first surface 41 resulting in a circular cutting edge. The inner perimeter 431 at the first surface 41 is smaller than the inner perimeter 432 at the second surface with the consequence that the three-dimensional shape of the aperture 430 resembles a truncated cone which tapers away from the first surface. Such geometry is less susceptible to clogging of the aperture by hairs or dead skin.

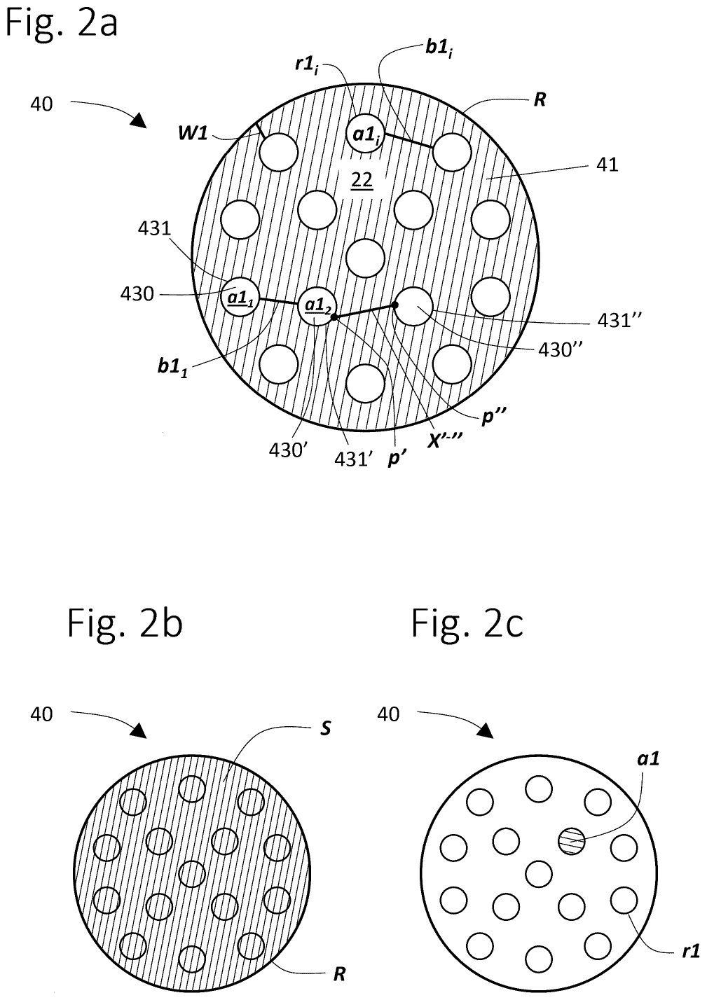

FIG. 2a depicts a top view of the first surface of skin treatment sheet 40, which has an outer perimeter R. The area enclosed by this outer perimeter is the total sheet area S.

The skin treatment sheet 40 comprises a number n of apertures 430, 430′, 430″, etc., each with an aperture area a1ᵢ (i=1 to n) on the first surface 41. The area a1ᵢ is defined as the open area enclosed by the aperture perimeter r1ᵢ of the apertures 430, 430′, 430″, etc. The summation of all the aperture areas a1ᵢ for all n apertures results in the total aperture area A1.

A1=Σᵢ₌₁ⁿa1ᵢ for i=1 to n

The apertures 430, 430′, 430″, etc. have a cutting edge along at least a portion of the first inner perimeter 431, 431′, 431″, etc. The cutting length l1ᵢ (i=1 to n) of the aperture 430 on the first surface 41 of treatment sheet 40 is defined as the length of the portion along the inner perimeter 431 that has a length along the inner perimeter r1ᵢ where a cutting edge is provided within the aperture 430. The summation of all of the cutting lengths l1ᵢ for all n apertures results in the total cutting length L1.

L1=Σᵢ₌₁ⁿl1ᵢ for i=1 to n

The skin treatment sheet comprises a number n of apertures 430, 430′, 430″, etc. For each aperture a closest adjacent aperture can be determined. A straight line X′ starting on any point p′ located on the inner perimeter 431′ of a first aperture 430′ and ending on any point p″ located on the inner perimeter 431″ of a second aperture 430″ can be drawn. The shortest aperture separation b1ᵢ between aperture 430 and the closest adjacent aperture 430′ is defined as the length of the shortest line that can be drawn in such a way between these two closest adjacent apertures. The shortest distance between two closest adjacent apertures 430 and 430′ is b1ᵢ.

The rim width W1 is the shortest distance that can be measured from the outer perimeter R to the inner perimeter r1 of any of the apertures adjacent to the outer perimeter R.

FIGS. 2b and 2c show the same treatment sheet 40 as in FIG. 2a. The area hatched in FIG. 2b indicates the sheet area S that is enclosed by the outer perimeter R. The area hatched in FIG. 2c indicates the aperture area al than is enclosed by the aperture perimeter r1.

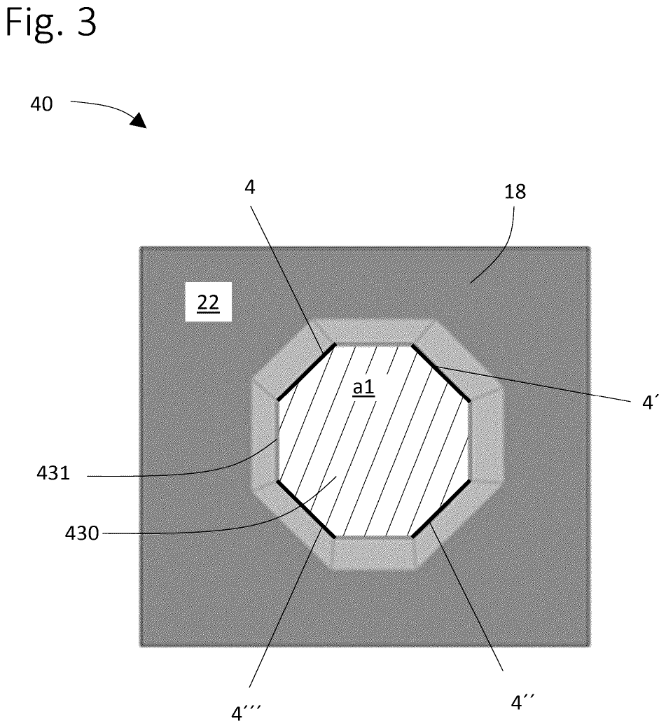

FIG. 3 is a top view onto the second surface of a treatment sheet 40 of the present invention. The treatment sheet 40 with a first surface 41 (not visible) and a second surface 42 comprises a substrate 22 of a first material 18 with an aperture 430 having the shape of an octagon. At the first surface 41 (not visible), the substrate 22 has an aperture with an inner perimeter 431 and an aperture area al (represented by the hatched area) of the aperture 430. In this embodiment, the cutting edges 4, 4′, 4″, 4′″ are shaped only in portions of the inner perimeter 431, i.e. every second side of the octagon has a cutting edge.

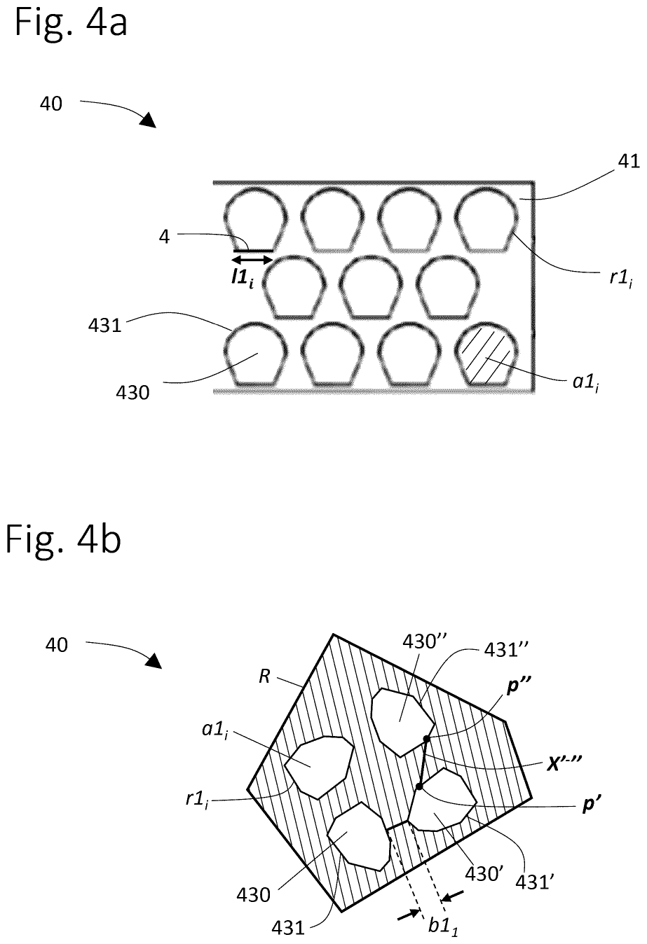

FIG. 4a shows the top view of the first surface 41 of a skin treatment sheet 40 which comprises a number n of complex shaped apertures 430, each with an aperture area a1ᵢ (i=1 to n) on the first surface 41 and a cutting edge 4 formed along a portion of the inner perimeter 431.

The cutting length l1ᵢ (i=1 to n) of an aperture 430 on the first surface 41 of the treatment sheet 40 is defined as the length of the portion along the inner perimeter 431 that has cutting edge 4 along the inner perimeter r1ᵢ where a cutting edge is provided within the aperture 430. The summation of all of the cutting lengths l1ᵢ for all n apertures results in the total cutting length L1.

L1=Σᵢ₌₁ⁿl1ᵢ for i=1 to n

FIG. 4b shows the top view of the first surface 41 of an alternative skin treatment sheet 40 which comprises a number n of randomly shaped and oriented apertures 430, 430′,430″,430′″, each with an aperture area a1ᵢ (i=1 to n) on the first surface 41.

The skin treatment sheet comprises a number n of apertures. For each aperture a closest adjacent aperture can be found. A straight line X′⁻″ starting on any pointp′ located on the inner perimeter 431′ of a first aperture 430′ and ending on any point p″ located on the inner perimeter 431″ of a second aperture 430″ can be drawn. The shortest aperture separation b1ᵢ between aperture 430 and the closest adjacent aperture 430′ is defined as the length of the shortest line that can be drawn in such a way between these two closest adjacent apertures.

The shortest distance between two closest adjacent apertures 430 and 430′ is b1ᵢ.

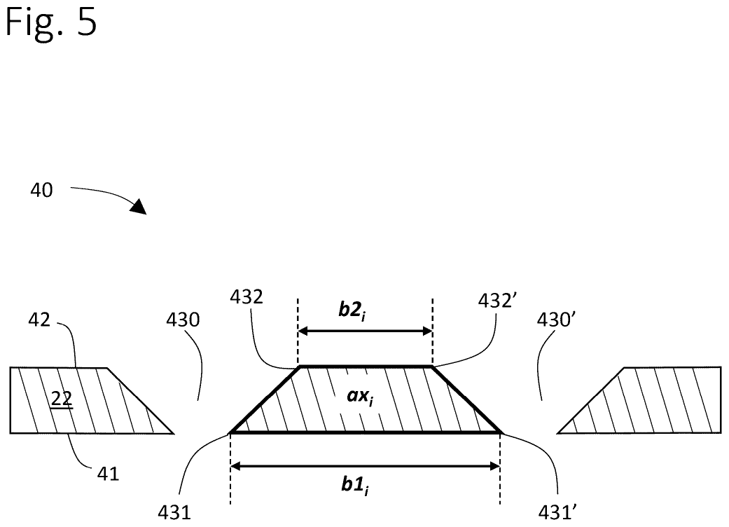

FIG. 5 shows cross-sections of a skin treatment sheet 40 taken normal to the plane of the first surface 41. The skin treatment sheet is formed from a substrate 22 and contains a plurality of apertures 430 with an inner perimeter of the aperture 431 on the first surface 41.

The shortest distance between two closest adjacent apertures on the first surface 41 is b1ᵢ. The shortest distance between two closest adjacent apertures on the second surface 42 is b2ᵢ.

A vertical cross section taken through the treatment sheet 40 taken normal to the plane of the first surface 41 and the second surface 42 along the line of b1ᵢ (shown for instance in FIG. 2a) characterizes an area axᵢ that is bounded by b1ᵢ, a corresponding shortest aperture distance b2ᵢ on the second surface 42 of the treatment sheet 40 and two cutting bevels that connect the inner perimeters 431 and 431′ on the first surface 41 to the inner perimeters 432 and 432′ on the second surface 42, respectively.

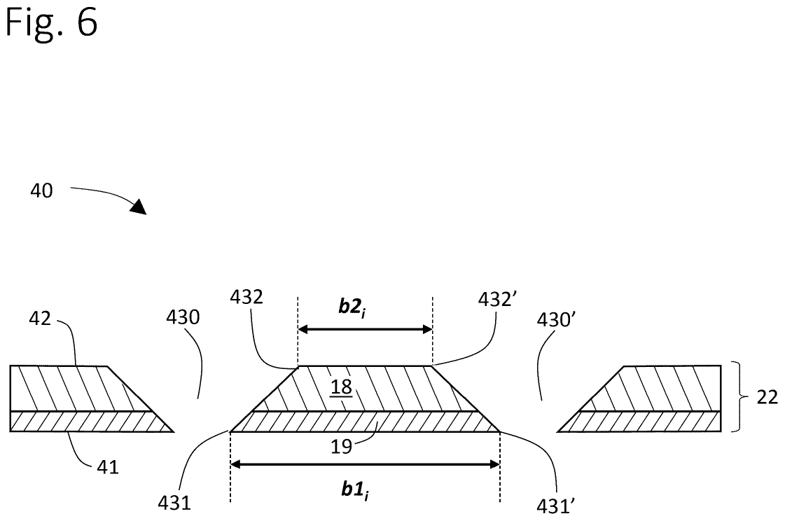

FIG. 6 shows a cross-section of a skin treatment sheet 40 taken normal to the plane of the first surface 41 and along the line of b1ᵢ which represents the shortest aperture separation between two closest adjacent apertures on the first surface 41. The skin treatment sheet is formed from a substrate 22 and contains a plurality of apertures 430 with an inner perimeter of the aperture 431 on the first surface 41. The substrate 22 comprises a first material 18, e.g. silicon, and a second material 19, e.g. a diamond layer, wherein the cutting edge is shaped along the perimeter 431 and in the second material 19.

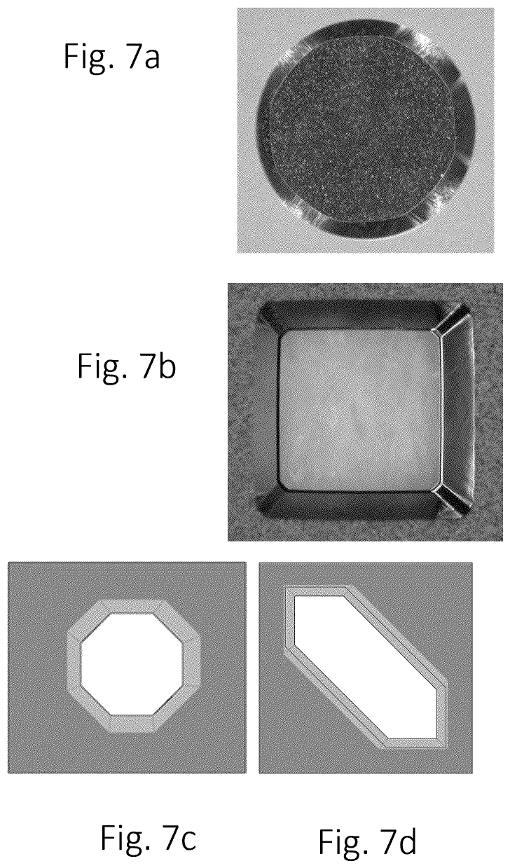

FIGS. 7a to 7d show top views onto the second surface 42 of alternative cutting apertures having different shapes in accordance with the present invention. The apertures can be circular (FIG. 7a), square (FIG. 7b), octagonal (FIG. 7c), or hexagonal (FIG. 7d) or combinations thereof.

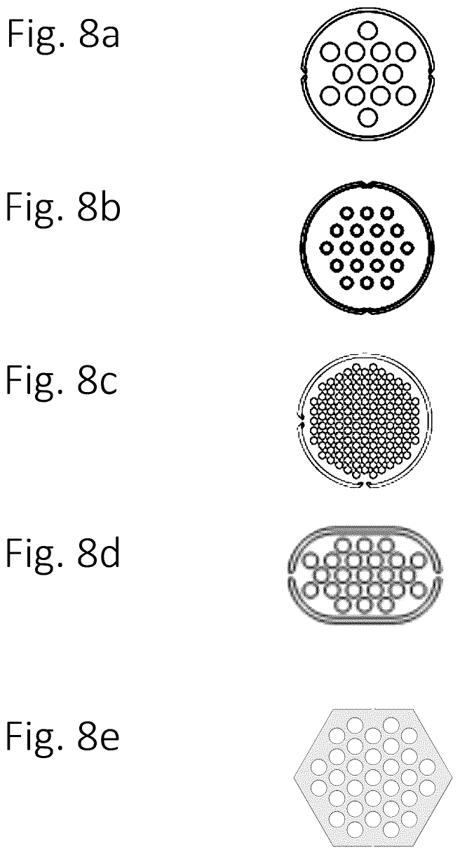

FIGS. 8a to 8e show top views onto the second surface 42 of different alternatives of skin treatment sheets according to the present invention with alternative number and arrangements of circular apertures. The transparency T of a treatment sheet 40 is defined as the ratio of total aperture area A1 divided by the total treatment sheet area S. The table below gives the transparency T expressed as a percentage for the skin treatment sheets shown in FIGS. 8a to 8e.

| | Transparency, |
|---|---|
| FIG. | T |
| FIG. 8a | 21% |
| FIG. 8b | 9% |
| FIG. 8c | 28% |
| FIG. 8d | 25% |
| FIG. 8e | 25% |

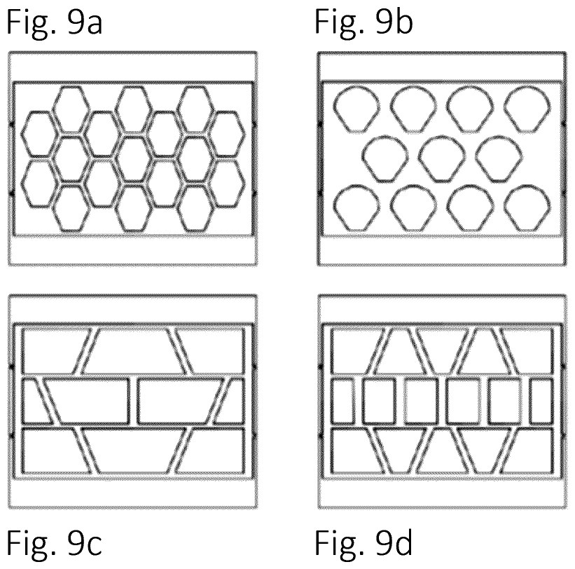

FIGS. 9a to 9d show top views onto the first surface 41 of different alternatives of skin treatment sheets according to the present invention with alternative geometries, i.e. different shapes of the apertures.

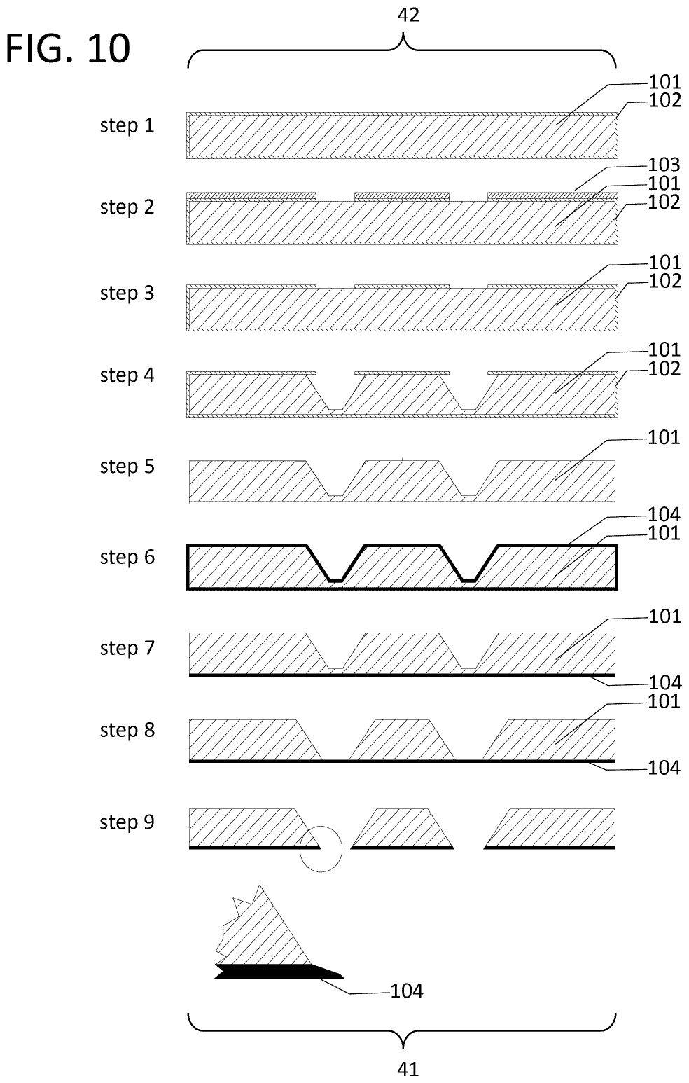

In FIG. 10 a flow chart of the inventive process is shown. In a first step 1, a silicon wafer 101 is coated by PE-CVD or thermal treatment (low pressure CVD) with a silicon nitride (Si₃N₄) layer 102 as protection layer for the silicon. The layer thickness and deposition procedure must be chosen carefully to enable sufficient chemical stability to withstand the following etching steps. In step 2, a photoresist 103 is deposited onto the Si₃N₄ coated substrate and subsequently patterned by photolithography. The (Si₃N₄) layer is then structured by e.g. CF₄-plasma reactive ion etching (RIE) using the patterned photoresist as mask. After patterning, the photoresist 103 is stripped by organic solvents in step 3. The remaining, patterned Si₃N₄ layer 102 serves as a mask for the following pre-structuring step 4 of the silicon wafer 101 e.g. by anisotropic wet chemical etching in KOH. The etching process is ended when the structures on the second surface 42 have reached a predetermined depth and a continuous silicon first surface 41 remains. Other wet- and dry chemical processes may be suited, e.g. isotropic wet chemical etching in HF/HNO₃ solutions or the application of fluorine containing plasmas. In the following step 5, the remaining Si₃N₄ is removed by, e.g. hydrofluoric acid (HF) or fluorine plasma treatment. In step 6, the pre-structured Si-substrate is coated with an approx. 10 μm thin diamond layer 104, e.g. nano-crystalline diamond. The diamond layer 104 can be deposited onto the pre-structured second surface 3 and the continuous first surface 41 of the Si-wafer 101 (as shown in step 6) or only on the continuous first surface 41 of the Si-wafer (not shown here). In the case of double-sided coating, the diamond layer 104 on the structured second surface 3 has to be removed in a further step 7 prior to the following edge formation step 9 of the cutting blade. The selective removal of the diamond layer 104 is performed e.g. by using an Ar/O₂-plasma (e.g. RIE or ICP mode), which shows a high selectivity towards the silicon substrate. In step 8, the silicon wafer 101 is thinned so that the diamond layer 104 is partially free standing without substrate material and the desired substrate thickness is achieved in the remaining regions. This step can be performed by wet chemical etching in KOH or HF/HNO₃ etchants or preferably by plasma etching in CF₄, SF₆, or CHF₃ containing plasmas in RIE or ICP mode. Adding O₂ to the plasma process will yield in a cutting edge formation of the diamond film (as shown in step 9). Process details are disclosed for instance in DE 198 59 905 A1.

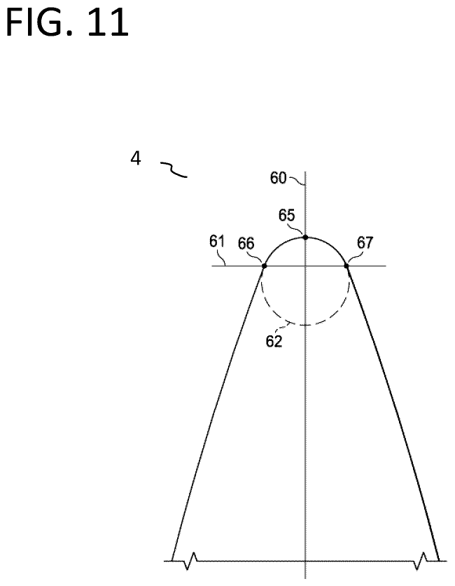

In FIG. 11, it is shown how the tip radius TR of a cutting edge can be determined. The tip radius TR is determined by first drawing a line 60 bisecting the cross-sectional image of the first bevel of the cutting edge 1 in half. Where line 60 bisects the first bevel point 65 is drawn. A second line 61 is drawn perpendicular to line 60 at a distance of 110 nm from point 65. Where line 61 bisects the first bevel two additional points 66 and 67 are drawn. A circle 62 is then constructed from points 65, 66 and 67. The radius of circle 62 is the tip radius TR for the cutting edge.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A skin treatment sheet comprising a substrate with a plurality of apertures, wherein:
the sheet has a first surface and an opposing second surface,
the apertures have a first inner perimeter at the first surface and a second inner perimeter at the opposing second surface,
at least two apertures have a cutting edge along at least a portion of the first inner perimeter,
each aperture has a closest adjacent aperture which is connected by a shortest distance line b1ᵢ on the first surface with a vertical cross-sectional substrate area axᵢ along the distance line b1ᵢ,
the skin treatment sheet has an average cross-sectional substrate area Ax defined as the average of all cross-sectional substrate areas axᵢ,
the skin treatment sheet has a stability ST, defined by the ratio of the average cross-sectional substrate area Ax and the total aperture area A1,
the skin treatment sheet has a total cutting length L1,
wherein the product of stability and total cutting length ST×L1 ranges from 0.01 to 10 mm.

2. The skin treatment sheet of claim 1, wherein the product of stability and total cutting length ST×L1 is from 0.05 to 5 mm, preferably from 0.1 to 2 mm.

3. The skin treatment sheet of claim 1, wherein the stability ST is in the range from 1×10⁻⁴ to 1×10⁻¹.

4. The skin treatment sheet of claim 1, wherein the closest adjacent apertures have a shortest distance b1ᵢ which is in the range of 0.1 to 3.5 mm.

5. The skin treatment sheet of claim 1, wherein the closest adjacent apertures are connected by a shortest distance line b2ᵢ on the second surface and the ratio b1ᵢ:b2ᵢ is in the range of 1.0 to 10.0.

6. The skin treatment sheet of claim 1, wherein the skin treatment sheet has an average cross-sectional substrate area Aₓ in the range from 0.01 to 1 mm².

7. The skin treatment sheet of claim 1, wherein the total sheet area S is from 100 to 800 mm².

8. The skin treatment sheet of claim 1, wherein the total aperture area A1 is from 10 to 400 mm².

9. The skin treatment sheet of claim 1, wherein the transparency of the sheet is from 5 to 60%.

10. The skin treatment sheet of claim 1, wherein the skin treatment sheet has an outer perimeter R with a rim width W1, wherein the rim width W1 is in a range from 0.1 to 5.0 mm.

11. The skin treatment sheet of claim 1, wherein the first inner perimeter is smaller than the second inner perimeter.

12. The skin treatment sheet of claim 1, wherein the sheet has a thickness of 20 to 1000 μm.

13. The skin treatment sheet of claim 1, wherein the substrate has from 5 to 200 apertures.

14. The skin treatment sheet of claim 1, wherein the cutting edge has a tip radius TR of 1 to 200 nm.

15. The skin treatment sheet of claim 1, wherein the sheet comprises a first material or a first material and a second material adjacent to the first material.

16. The skin treatment sheet of claim 15, wherein the first material is selected from the group consisting of:
metals, preferably titanium, nickel, chromium, niobium, tungsten, tantalum, molybdenum, vanadium, platinum, germanium, iron, and alloys thereof, in particular steel,
ceramics comprising at least one element selected from the group consisting of carbon, nitrogen, boron, oxygen or combinations thereof, preferably silicon carbide, zirconium oxide, aluminum oxide, silicon nitride, boron nitride, tantalum nitride, TiAlN, TiCN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face (2), wafer orientation <100>, <110>, <111>or <211>,
single crystalline materials,
glass or sapphire,
polycrystalline or amorphous silicon or germanium,
mono- or polycrystalline diamond, diamond like carbon (DLC), adamantine carbon and
combinations thereof.

17. The skin treatment sheet of claim 15, wherein the second material is selected from the group consisting of:
oxides, nitrides, carbides, borides, preferably aluminum nitride, chromium nitride, titanium nitride, titanium carbon nitride, titanium aluminum nitride, cubic boron nitride,
boron aluminum magnesium,
carbon, preferably diamond, poly-crystalline diamond, nano-cystalline diamond, diamond like carbon (DLC) like tetrahedral amorphous carbon, and
combinations thereof.

18. The skin treatment sheet of claim 15, wherein the cutting edge is shaped in the second material.

19. The skin treatment sheet of claim 1, wherein the apertures have a shape which is selected from the group consisting of circular, ellipsoidal, square, triangular, rectangular, trapezoidal, hexagonal, octagonal and combinations thereof

20. A skin treatment device comprising the skin treatment sheet of claim 1.
